(19) United States
(12) Patent Application Publication
(10) Pub. No.: US 2017/0106773 A1
(43) Pub. Date: Apr. 20, 2017

(54) INTEGRATED FOLDING CRATE

(71) Applicant: FORD GLOBAL TECHNOLOGIES, LLC, Dearborn, MI (US)

(72) Inventor: Eduardo Arturo Aguilar Ruelas, Mexico City (MX)

(21) Appl. No.: 14/885,638

(22) Filed: Oct. 16, 2015

(51) Int. Cl. B60N 2/32; B60R 22/34

(52) U.S. Cl. CPC B60N 2/32; B60R 22/34

(57) ABSTRACT

An integrated holder for a vehicle is provided, defined by at least one pivoting seat bottom, a restraint for maintaining the seat bottom in a substantially upright position, and at least one deployable side wall associated with the at least one pivoting seat bottom. A support member supports the deployable side wall. The restraint may be one or both of a vehicle seat belt and a deploying/dampening mechanism. In combination, the at least one pivoting seat bottom, at least one side wall, and restraint define defining the integrated holder when deployed. The integrated holder may further be provided with a removable top cover.

### TECHNICAL FIELD

This disclosure relates generally to storage carriers for vehicles. More particularly, the disclosure relates to a deployable carrier for a motor vehicle, the carrier being conveniently integrated into a seating element of the vehicle for easy access and use.

### BACKGROUND

There is a need in motor vehicles to provide suitable holders or carriers for items being transported. For example, people often travel in their motor vehicles with their pets, for example for veterinary appointments, when moving, or even simply for companionship. However, an unrestrained animal in a vehicle presents a driver distraction and so potentially a hazard. Additionally, in the event of even a minor collision, an unrestrained animal is subject to severe injury. Still more, even a small unrestrained pet or other items such as cell phones, packages, groceries, etc. subjected to deceleration forces in a collision becomes a dangerous projectile that can injure the vehicle occupants.

For these and other reasons, various means of restraining animals and/or containing transported items in a vehicle have been developed. It is known, for example, to restrain animals by attaching a leash or other tether at one end to a collar or harness worn by the animal and at the other end to a portion of the vehicle such as a seatbelt harness, door handle, etc. This type of restraint likewise risks injury to the animal during a collision, since the animal will travel at least a short distance before reaching the end of the leash, exacerbating the deceleration force of the collision. Also, a leashed pet may be less likely to exercise restraint in relieving itself in the vehicle at need.

It is likewise known to use pet carriers to transport an animal in a vehicle. These are typically simply conventional carriers or crates as would be used in a home or kennel, placed loose in the vehicle and into which the animal is placed prior to operating the vehicle. However, unrestrained crates likewise can become projectiles during a collision, risking injury to vehicle occupants. Conventional crates or pet carriers, while effective in restraining an animal, are also inconvenient in that they occupy significant space in a vehicle even if no pet is present.

To solve this and other problems, the present disclosure relates at a high level to a deployable holder suitable for use as a pet carrier or for holding other items being transported in a vehicle. Advantageously, the described holder is provided integrated into a seat member of a motor vehicle, in embodiments includes collapsible side walls and a top cover for security, and in embodiments includes a convenient deploying/dampening mechanism and restraint element.

### SUMMARY

In accordance with the purposes and benefits described herein, in one aspect an integrated deployable seat-mounted holder assembly for a vehicle is described, including at least one pivoting seat bottom and a restraint for maintaining the at least one deployed pivoting seat bottom in a substantially upright position.

In embodiments, the holder assembly includes at least one deployable side wall, whereby the at least one pivoting seat bottom, at least one side wall, and restraint in combination define the integrated holder when in a deployed configuration. A support member may be provided for supporting the at least one deployable side wall. The restraint may be provided by one or both of a vehicle seat belt and a deploying/dampening mechanism. In an embodiment, the deploying/dampening mechanism is at least one gas spring which when released biases the at least one pivoting seat bottom into a substantially upright configuration. The gas spring may further include a locking position for maintaining that upright position. A removable top cover may be included for the deployed holder.

In other aspects, seat assemblies are described including the integrated deployable seat-mounted holder. In still other aspects, deployable holders are described.

In the following description, there are shown and described embodiments of the disclosed deployable holder. As it should be realized, the holder is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed deployable holder, and together with the description serve to explain certain principles thereof. In the drawing:

FIG. 1A depicts a vehicle seat including an integrated holder according to the present disclosure;

FIG. 1B depicts a release mechanism for one of the integrated holders of FIG. 1;

FIG. 2A is a side view of the vehicle seat of FIG. 1, with a pivoting seat bottom portion deploying;

FIG. 2B shows the pivoting seat bottom portion of FIG. 2A in the fully upright position;

FIG. 2C shows an alternative embodiment of the pivoting seat bottom of FIG. 2B;

FIG. 2C-1 shows an isolated view of a pivoting support for a pivoting seat bottom;

FIG. 2C-2 shows an isolated view of a notch for engaging the pivoting support of FIG. 2C-1;

FIG. 3A shows an embodiment of a gas spring for deploying the pivoting seat bottom of FIGS. 2A-2B;

FIG. 3B shows the embodiment of FIG. 3A in a retracted configuration;

FIG. 3C shows the embodiment of FIG. 3B in an extended configuration;

FIG. 4A depicts a first pivoting seat bottom portion in the fully upright configuration;

FIG. 4B depicts a second pivoting seat bottom portion in the fully upright configuration;

FIG. 5A depicts a deployed holder according to the present disclosure, including deployed flexible side walls;

FIG. 5B depicts an alternative embodiment of the holder of FIG. 5A including a support member for the flexible side walls.

FIG. 5C depicts an alternative embodiment of the holder of FIG. 5A;

FIG. 5D depicts another alternative embodiment of the holder of FIG. 5A; and

FIG. 5E depicts yet another alternative embodiment of the holder of FIG. 5A.

Reference will now be made in detail to embodiments of the disclosed deployable holder, examples of which are illustrated in the accompanying drawing figures wherein like reference numerals identify like features.

### DETAILED DESCRIPTION

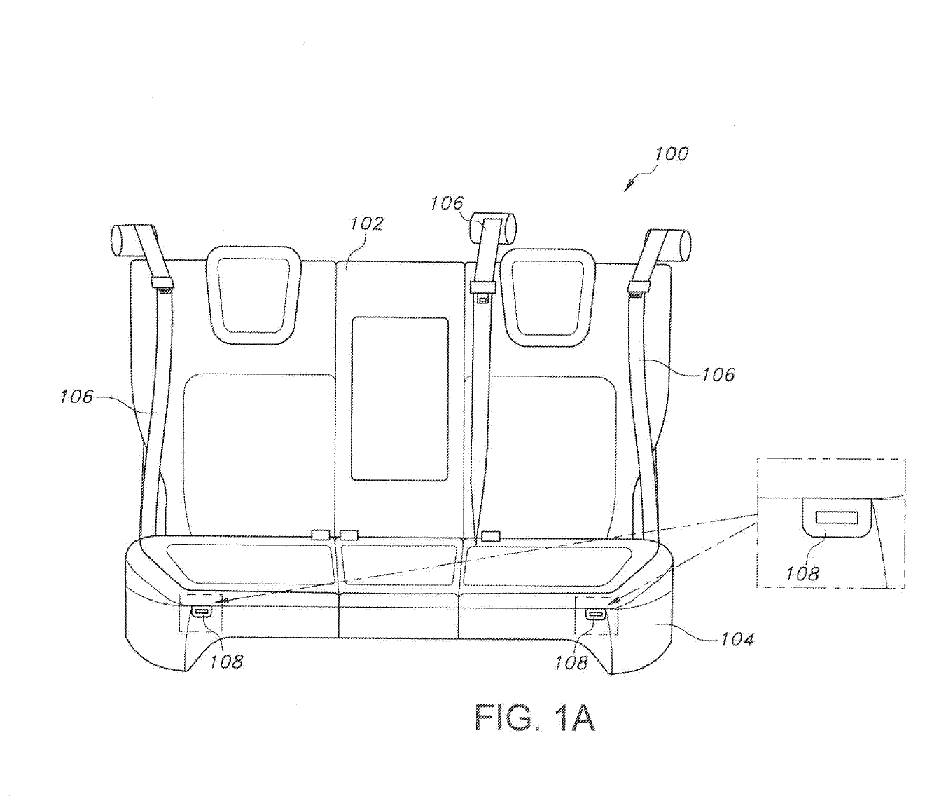

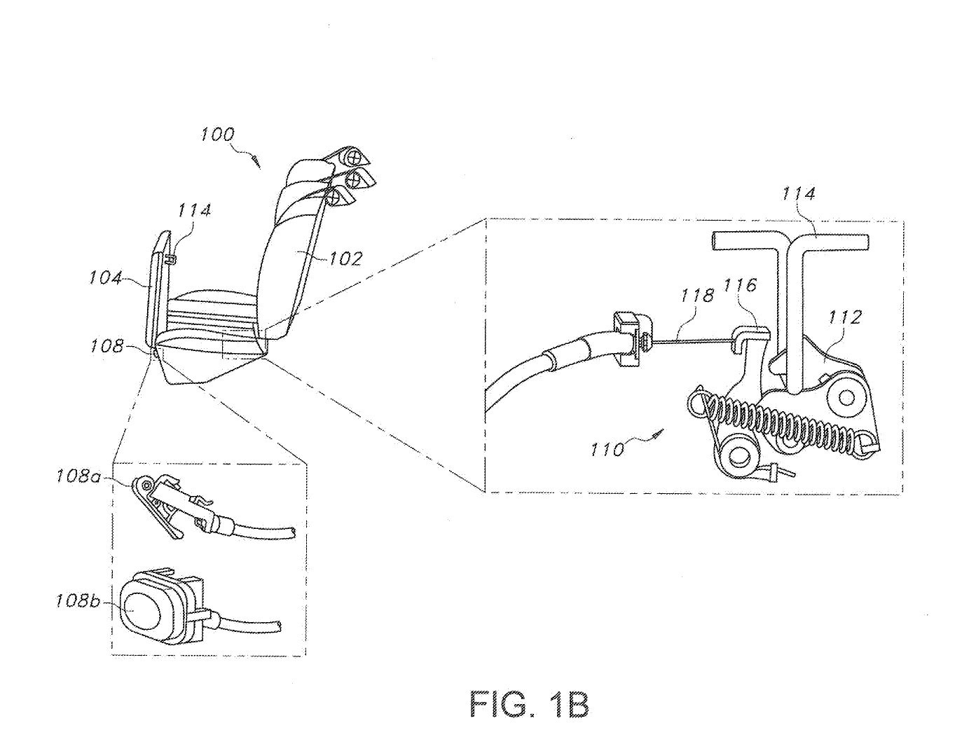

Turning to FIG. 1A, a vehicle seat 100 including an integrated holder (not shown in this view) is depicted. Seat 100 includes a seat back 102, a seat bottom 104, and several seat belt harnesses 106. A release mechanism is provided to release the integrated holder, actuated by one or more releases 108. Any suitable release mechanism is contemplated. As shown in FIG. 1B, in an embodiment a release mechanism 110 is provided including a latch 112 for capturing a striker 114 mounted on the seat bottom 104. A release 116 is operatively associated with the latch 112 and also with the release 108 by way of a cable 118. Release 108 may be a latch release 108a, a push-button release 108b, or any suitable such mechanism.

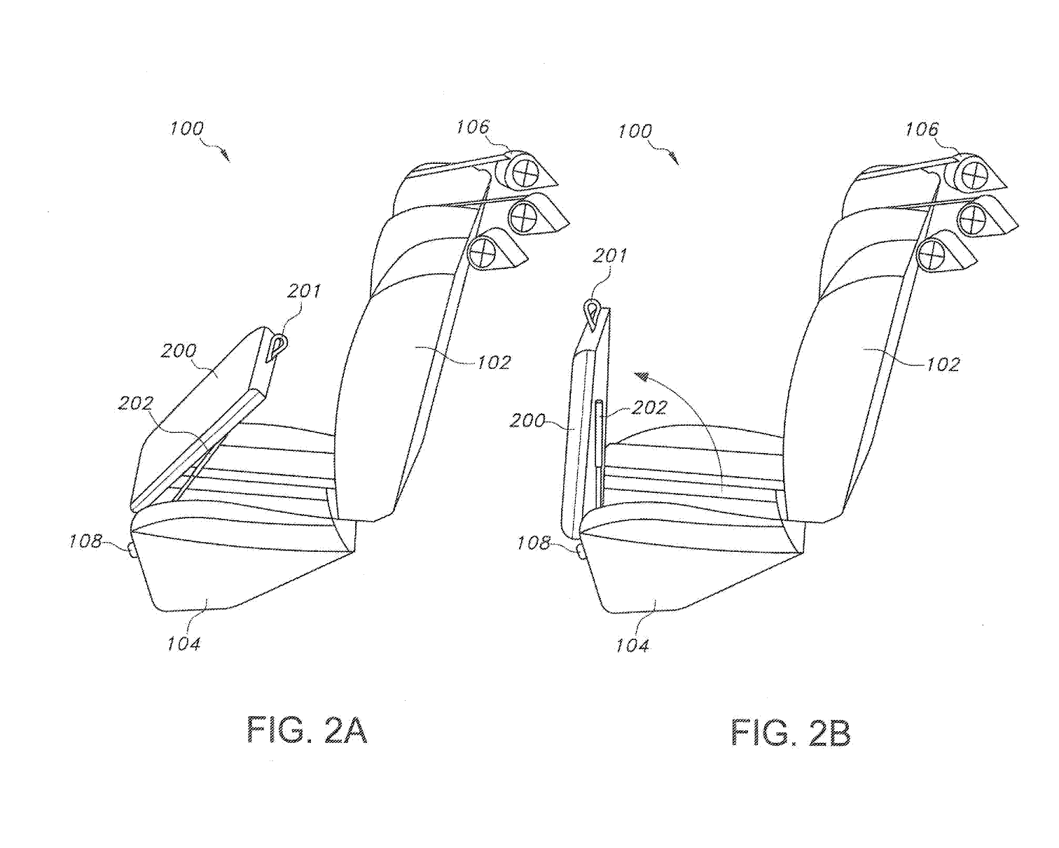

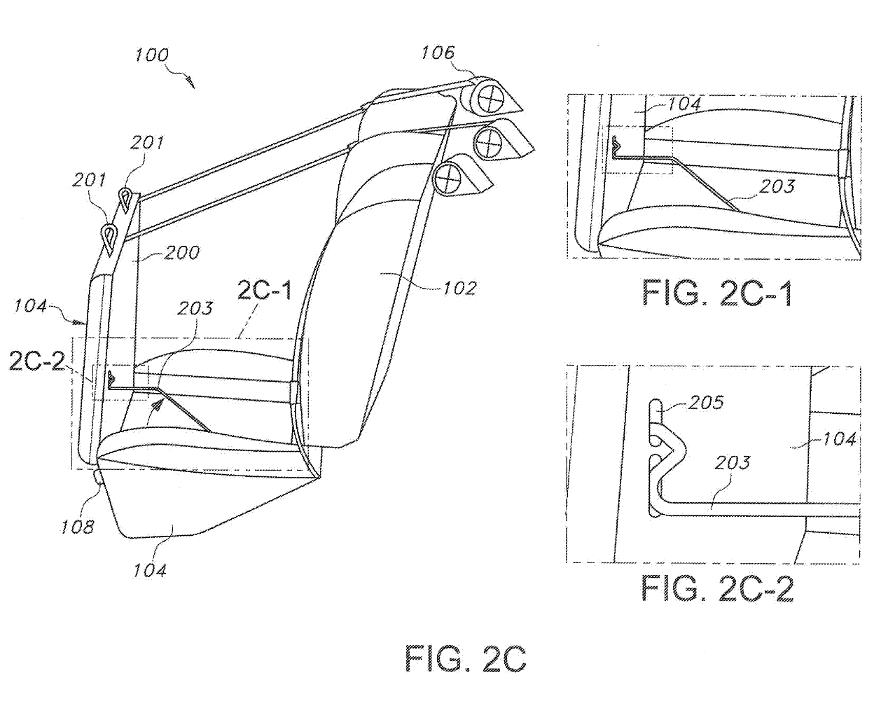

As best shown in FIGS. 2A-2B, at least a portion 200 of seat bottom 104 is hingedly configured to, when released using release 108, pivot in a vehicle forward direction (see arrow) to a substantially upright configuration as shown in FIG. 2B. One or more straps 201 may be provided at a top edge of seat bottom 104 to assist the user in pivoting the seat bottom.

In an embodiment, a manually-operated pivoting support 203 may be provided to engage a notch 205 in seat bottom 104, to assist in maintaining the seat bottom 104 in a substantially upright position (see FIG. 2C). In an embodiment, to assist both in deployment of the integrated holder and in maintaining the seat bottom 104 in a substantially upright position, optionally a deploying/dampening mechanism 202 is provided. As will be appreciated, a deploying mechanism 202 including a dampening feature provides a smooth and assisted translation of pivoting portion 200 between the deployed and the closed configuration. In an alternative embodiment, a manually-operated pivoting support 203 may be provided to engage a notch 205 in seat bottom 104, to assist in maintaining the seat bottom 104 in a substantially upright position (see FIG. 2C-1).

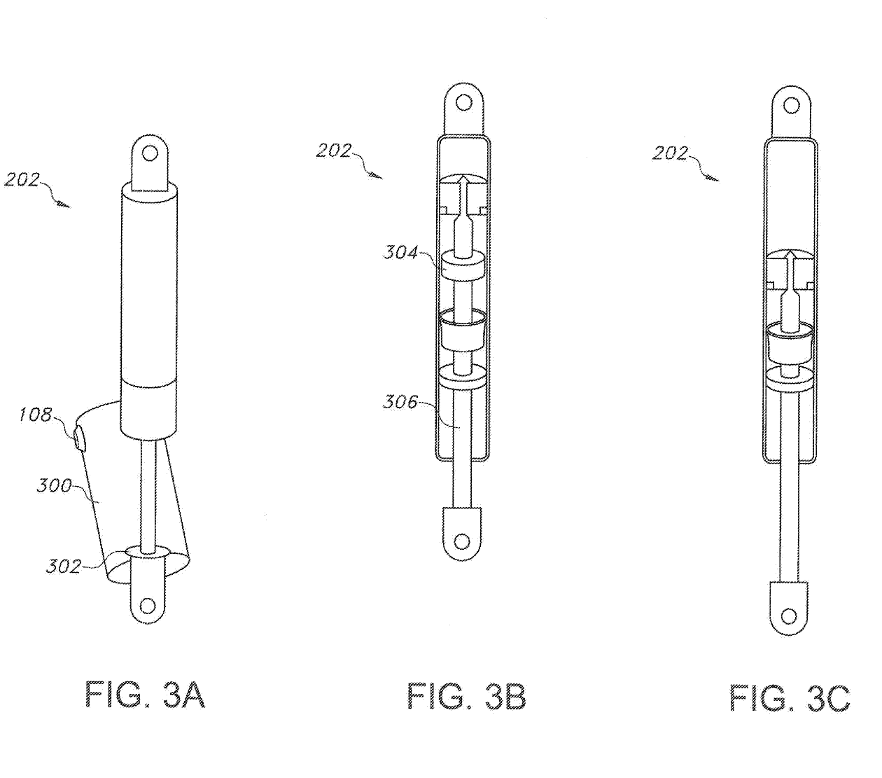

In an embodiment (see FIGS. 3A-3C), deploying/dampening mechanism 202 is a gas spring of known configuration which uses a compressed gas to extend the mechanism to an extended configuration (see FIG. 3C), thus urging pivoting portion 200 in the vehicle forward direction to the substantially upright configuration shown in FIG. 2B. Release 108, held on a support tube 300, interacts with a leaf spring 302 to cause the gas spring to deploy to an extended configuration as shown in FIG. 3C. Such gas springs are well known in the automotive arts, for example for deploying lift gates, tailgates, etc. A variety of designs of suitable gas springs are known in the art and contemplated for use herein. In the embodiment depicted in FIGS. 3A-3C, the gas springs include a cooperating cam drum 304/cam sleeve 306 which lock the deployed gas spring in an extended position. However, alternative designs of gas spring are known in the art and contemplated for use herein. In turn, other types of deploying mechanisms are known, including mechanical spring-actuated cylinders, gas-dampened spring cylinders, and others. In turn, alternative locking mechanisms are known including spring tube latches, set-screw type latches, and others. Accordingly, the embodiment depicted in the Figures is representative only.

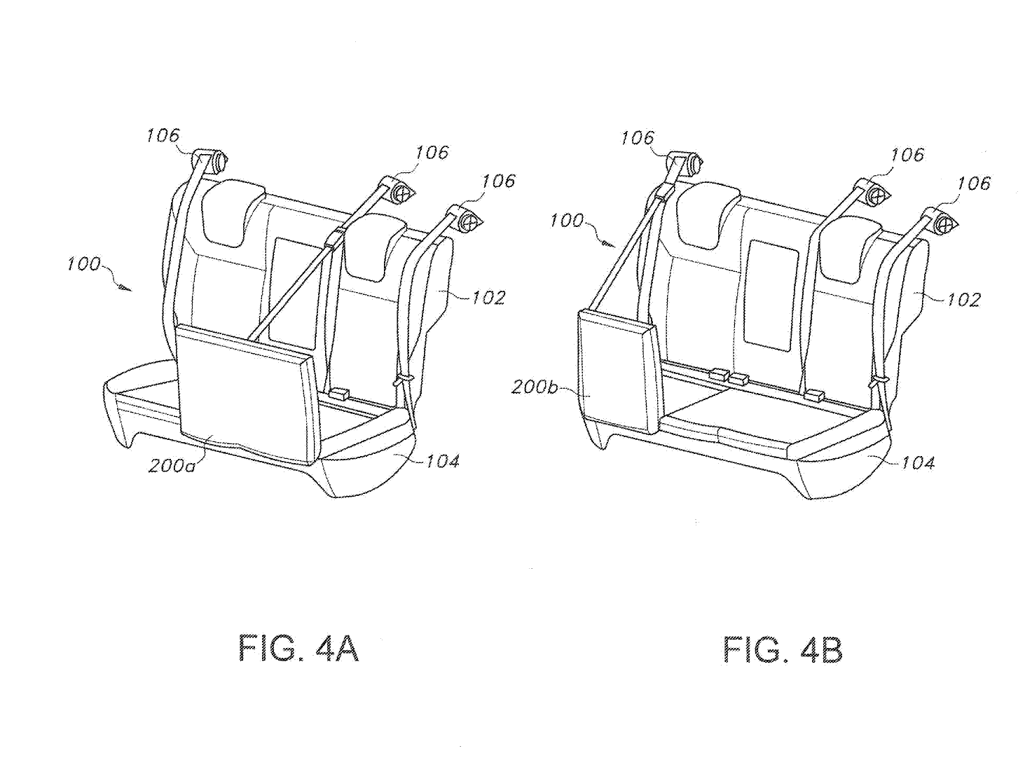

As shown in FIGS. 4A-4B, multiple portions of seat bottom 104 may be configured to pivot as described above. In the depicted embodiment, two portions 200a, 200b, such as for the seat bottom of a 60:40 bench seat, are configured to pivot. However, it will be appreciated that fewer or more portions of seat bottom 104 may be configured to pivot as described. As shown, one or more of seat belts 106 may be used to retain the pivoting portions 200a, 200b in the upright configuration. This provides a supplemental restraint in the event of a sudden deceleration, avoiding damage to the described deploying/dampening mechanism 202. When deployed as described, seat back 102 and pivoting portions 200a and/or 200b define the rear and front walls, respectively, of holders. This may be sufficient to safely carry certain items in the vehicle.

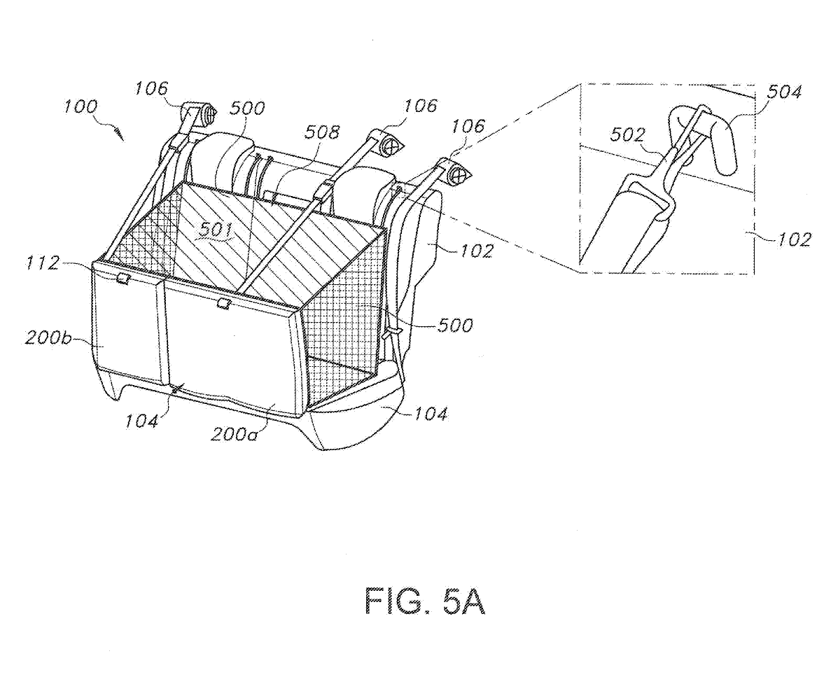

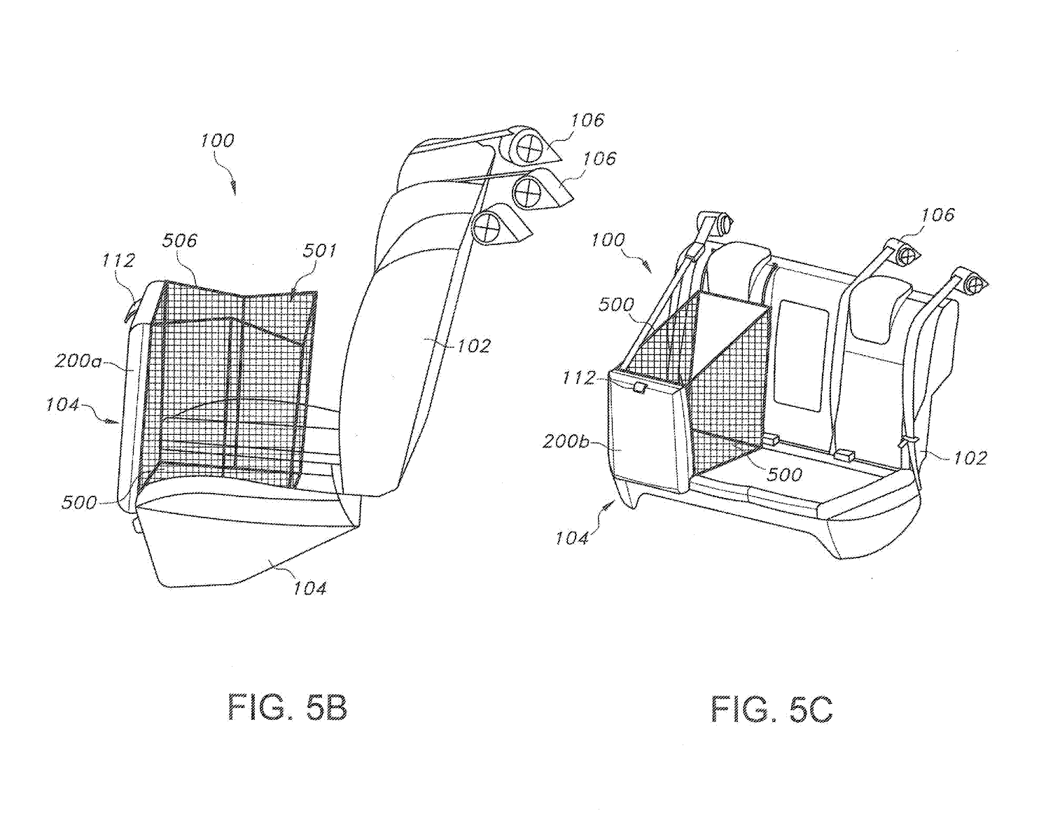

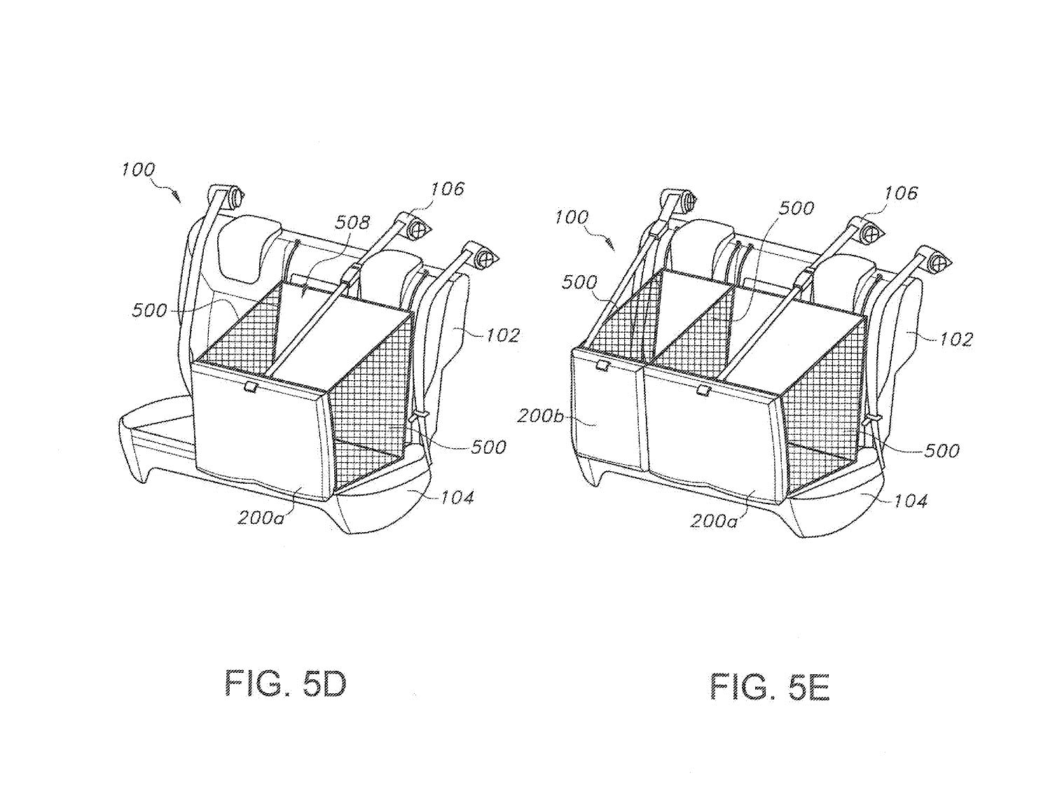

However, side walls are desirable for carrying most items, particularly items that are likely to be displaced by inertia or pets that are likely to move of their own volition. To address this, with reference to FIG. 5A a deployable side wall is provided, comprising one or more flexible panels 500 which when deployed define a holder 501. Flexible panels 500 may be fabricated of any suitable material. In embodiments, flexible panels 500 are fabricated of a suitable mesh material to allow air flow. The edges of the flexible panels 500 may be secured to one or both of seat back 102 and seat bottom 104 by any suitable means, for example by associated clips 502 which attach to cooperating strikers 504 positioned on seat back 102 and seat bottom 104.

In an alternative embodiment (see FIG. 5B), a support member 506 is included for supporting flexible panels 500. In the depicted embodiment, support member 506 is a pop-up wire frame attached to the edges of flexible panels 500. As will be appreciated, advantageously a pop-up wire frame will fold up when pivoting portion 200a is folded down (see FIG. 1), but will pop-up to deploy side walls 500 when pivoting portion 200a is folded in a vehicle forward direction as described (see FIG. 2B).

Optionally, a removable top cover 508 for holder 501 may be provided. As will be appreciated, the top cover adds to safety aspects of the described holder, preventing inadvertent escape of animals confined in holder 400, inadvertent dislodgement of items held in the holder, etc. The top cover 508 may be secured to side walls 500 and/or support member 502 by any suitable means, including without limitation zippers, hook-and-loop material, snaps, buttons, and others.

Thus, it will be appreciated that a simple, effective vehicle-mounted holder is provided, which because of its integration into a vehicle seat structure has no impact on available storage/seating space in the vehicle when not deployed. The holder is easily deployed for use as needed, and equally easily closed for storage when not needed.

Obvious modifications and variations are possible in light of the above teachings. For example, as depicted flexible panels 500 are provided to define a holder spanning an entire width dimension of the vehicle seat 100. However, it will be readily appreciated that in alternative embodiments, flexible panels may be provided spanning only a width of seat bottom portion 200a (see FIG. 5C), or only a width of seat bottom portion 200b (see FIG. 5D). In yet another embodiment (see FIG. 5E), an intermediate flexible panel 500 may be provided to define a divided holder spanning the entire width dimension of the vehicle seat 100. All such modifications and variations are within the scope of the appended claims when interpreted in accordance with the breadth to which they are fairly, legally and equitably entitled.

What is claimed:

1. A seat assembly for a vehicle, comprising:
a seat element defined by a seat back and at least one pivoting seat bottom configured to pivot in a vehicle forward direction; and
a restraint for maintaining the deployed at least one pivoting seat bottom in a substantially upright position;
the at least one pivoting seat bottom and restraint in combination defining a holder when in a deployed configuration.

2. The assembly of claim 1, further including at least one deployable side wall.

3. The assembly of claim 2, including left and right deployable side walls.

4. The assembly of claim 2, further including a support member for supporting the at least one deployable side wall.

5. The assembly of claim 1, wherein the restraint comprises a vehicle seat belt.

6. The assembly of claim 1, wherein the restraint comprises a deploying/dampening mechanism.

7. The assembly of claim 6, wherein the deploying/dampening mechanism is at least one gas spring for deploying the at least one pivoting seat bottom and having a locking position for maintaining the deployed at least one pivoting seat bottom in a substantially upright position.

8. The assembly of claim 1, further including a removable top cover for the deployed holder.

9. A vehicle including the assembly of claim 1.

10. An integrated holder assembly for a vehicle, comprising:
at least one pivoting seat bottom;
a restraint for maintaining the deployed at least one pivoting seat bottom in a substantially upright position; and
at least one deployable side wall;
the at least one pivoting seat bottom, at least one side wall, and restraint in combination defining the integrated holder when in a deployed configuration.

11. The holder assembly of claim 10, including left and right deployable side walls.

12. The holder assembly of claim 10, further including a support member for supporting the at least one deployable side wall.

13. The holder assembly of claim 10, wherein the restraint comprises a vehicle seat belt.

14. The holder assembly of claim 10, wherein the restraint comprises a deploying/dampening mechanism.

15. The holder assembly of claim 14, wherein the deploying/dampening mechanism is at least one gas spring for deploying the at least one pivoting seat bottom and having a locking position for maintaining the deployed at least one pivoting seat bottom in a substantially upright position.

16. The holder assembly of claim 10, further including a removable top cover for the deployed holder.

17. A vehicle including the holder assembly of claim 10.

18. A deployable holder assembly for a vehicle, comprising:
at least one pivoting seat bottom configured to pivot in a vehicle forward direction;
a restraint for maintaining the deployed at least one pivoting seat bottom in a substantially upright position; and
left and right deployable side walls;
the at least one pivoting seat bottom, deployable side walls, and restraint in combination defining the integrated holder when in a deployed configuration.

19. The assembly of claim 18, further including a support member for supporting the left and right deployable side walls.

20. The assembly of claim 18, wherein the restraint comprises one or both of a vehicle seat belt and a gas spring deploying/dampening mechanism.
